(19) United States
(12) Patent Application Publication
(10) Pub. No.: US 2023/0100265 A1
(43) Pub. Date: Mar. 30, 2023

(54) METHODS AND SYSTEMS FOR INTEGRATION OF EXTERNAL CALCULATIONS TO CORE HEURISTIC ALGORITHMS

(71) Applicant: Kinaxis Inc., Ottawa (CA)

(72) Inventors: Kenneth HO, Ottawa (CA); Rob MACMILLAN, Ottawa (CA); Yankai ZHANG, Ottawa (CA)

(21) Appl. No.: 17/952,698

(22) Filed: Sep. 26, 2022

Related U.S. Application Data
(60) Provisional application No. 63/248,649, filed on Sep. 27, 2021.

(51) Int. Cl. G06N 5/00; G06Q 10/08

(52) U.S. Cl. CPC G06N 5/003; G06Q 10/08

(57) ABSTRACT

A computer-implemented method which includes receiving a set of external supplies and one or more external outputs based on an external calculation. The output is converted into a converted format that is receivable by a heuristic application. Thereafter, warm start data is generated from the converted format, which in turn, is converted , converting to a set of converted warm start data. A set of demands and one or more inputs, along with the set of converted warm start data, is input to the heuristic. Application of the heuristic results in generating a set of supplies and one or more outputs.

### CROSS-REFERENCE TO RELATED APPLICATIONS

The present application claims the benefit of U.S. Patent Application No. 63/248,649, filed Sep. 27, 2021, and is expressly incorporated by reference in its entirety herein.

### BACKGROUND

External calculations can be slow, hard to fit into internal heuristic algorithms.

Often, in complex planning problems, there are two general approaches. One approach is to use heuristics (namely, a set of rules) to arrive at a satisfactory solution, with relatively low run-time. With heuristics, the scope of a solution space is somewhat limited—thus, a heuristic-based solution may not be the best solution, but may be adequate. Another approach is the use of optimization techniques in which mathematical formulae are created, and optimized, in order to solve a problem. An approach based on optimization has an expanded solution space, and thus an optimal solution may be found. While the quality of the solution is superior to that obtained via heuristics, the drawback is that optimization requires much larger run-time (than a heuristics approach) to execute.

Therefore, a heuristics-based approach may not provide the “best” solution to a complex planning problem, but can provide a very good solution based on a limited number of options that are presented. As an example, when responding to a crisis in supply chain planning, such as an unexpected plant shut down, or a landslide, or sudden change in transportation rates, a heuristics-based approach can find a solution in relatively quick time. An optimization approach will require running an optimization algorithm with different parameters and/or models, which required more run-time than a heuristics-based approach.

It is very difficult to bring these two methods together. Not only are the respective approaches different; often times, even the goals of each respective method can be quite different.

### BRIEF SUMMARY

Disclosed herein are methods and systems for integration of the output of external calculations to internal heuristics algorithms. An open interface allows external calculation to influence core algorithms, to improve solution quality and/or agility.

External calculations, such as optimization, can produce advanced results towards much flexible business targets, with this interface, core algorithms can respect benefit of the better solution quality, or blend the external calculation with internal core algorithm calculations. Systems and methods disclosed herein can also enable a balance of speed and quality. In some embodiments, input can be taken from any external calculations, such as previous heuristics result, Machine-learning output, optimization result or a third-party result.

In one aspect, a computer-implemented method includes receiving, by a processor, a set of external supplies and one or more external outputs based on an external calculation, converting, by the processor, a format of the set of external supplies and the one or more external outputs into a converted format that is receivable by a heuristic application, generating, by the processor, warm start data from the converted format, converting, by the processor, the warm start data to a set of converted warm start data, inputting, by the processor, a set of demands and one or more inputs, to the heuristic, inputting, by the processor, the set of converted warm start data to the heuristic, applying, by the processor, the heuristic to the set of demands, the one or more inputs, and the set of warm start data, and generating, by the processor, a set of supplies and one or more outputs based on the heuristics applied to the set of demands, the one or more inputs, and the set of converted warm start data.

The computer-implemented method may also include, prior to inputting the set of converted warm start data to the heuristic, loading, by the processor, the warm start data, converting, by the processor, the warm start data to a set of warm start demands, merging, by the processor, the set of warm start demands into a list includes the set of demands and a set of calculated demands, and sorting, by the processor, the list according to a user-defined configuration.

The external calculation can be based on machine learning, optimization or a second heuristic. The external calculation can be the heuristic, the heuristic having an input configuration that is different from the set of demands and the one or more inputs.

When converting the warm start data to the set of warm start demands, the computer-implemented method may also include selecting, by the processor, a piece of warm start data, creating, by the processor, a warm start demand from the piece of warm start data, the warm start demand having a demand construct includes basic demand information, the demand construct receivable by the heuristic, and incorporating, by the processor, additional warm start demand information into the demand construct of the warm start demand.

Basic demand information may include a part name, a part quantity and a due date. Other technical features may be readily apparent to one skilled in the art from the following figures, descriptions, and claims.

In one aspect, a system includes a processor. The system also includes a memory storing instructions that, when executed by the processor, configure the system to receive, by the processor, a set of external supplies and one or more external outputs based on an external calculation, convert, by the processor, a format of the set of external supplies and the one or more external outputs into a converted format that is receivable by a heuristic application, generate, by the processor, warm start data from the converted format, convert, by the processor, the warm start data to a set of converted warm start data, input, by the processor, a set of demands and one or more inputs, to the heuristic, input, by the processor, the set of converted warm start data to the heuristic, apply, by the processor, the heuristic to the set of demands, the one or more inputs, and the set of warm start data, and generate, by the processor, a set of supplies and one or more outputs based on the heuristics applied to the set of demands, the one or more inputs, and the set of converted warm start data.

Prior to inputting the set of converted warm start data to the heuristic, the system can also be further configured to load, by the processor, the warm start data, convert, by the processor, the warm start data to a set of warm start demands, merge, by the processor, the set of warm start demands into a list includes the set of demands and a set of calculated demands, and sort, by the processor, the list according to a user-defined configuration.

The external calculation can be based on machine learning, optimization or a second heuristic. The external calculation can be the heuristic, the heuristic having an input configuration that is different from the set of demands and the one or more inputs.

When converting the warm start data to the set of warm start demands, the system can be further configured to select, by the processor, a piece of warm start data, create, by the processor, a warm start demand from the piece of warm start data, the warm start demand having a demand construct includes basic demand information, the demand construct receivable by the heuristic, and incorporate, by the processor, additional warm start demand information into the demand construct of the warm start demand.

The basic demand information may include a part name, a part quantity and a due date. Other technical features may be readily apparent to one skilled in the art from the following figures, descriptions, and claims.

In one aspect, a non-transitory computer-readable storage medium, the computer-readable storage medium including instructions that when executed by a computer, cause the computer to receive, by a processor, a set of external supplies and one or more external outputs based on an external calculation, conversion, by the processor, of a format of the set of external supplies and the one or more external outputs into a converted format that is receivable by a heuristic application, generate, by the processor, warm start data from the converted format, convert, by the processor, the warm start data to a set of converted warm start data, inputting, by the processor, a set of demands and one or more inputs, to the heuristic, inputting, by the processor, the set of converted warm start data to the heuristic, apply, by the processor, the heuristic to the set of demands, the one or more inputs, and the set of warm start data, and generate, by the processor, a set of supplies and one or more outputs based on the heuristics applied to the set of demands, the one or more inputs, and the set of converted warm start data.

Prior to inputting the set of converted warm start data to the heuristic, the instructions that when executed by the computer, can further cause the computer to load, by the processor, the warm start data, convert, by the processor, the warm start data to a set of warm start demands, merge, by the processor, the set of warm start demands into a list includes the set of demands and a set of calculated demands, and sort, by the processor, the list according to a user-defined configuration.

The external calculation can be based on machine learning, optimization or a second heuristic. The external calculation can be the heuristic, the heuristic having an input configuration that is different from the set of demands and the one or more inputs. Other technical features may be readily apparent to one skilled in the art from the following figures, descriptions, and claims.

When converting the warm start data to the set of warm start demands, the instructions that when executed by the computer, can further cause the computer to select, by the processor, a piece of warm start data, create, by the processor, a warm start demand from the piece of warm start data, the warm start demand having a demand construct includes basic demand information, the demand construct receivable by the heuristic, and incorporate, by the processor, additional warm start demand information into the demand construct of the warm start demand.

The basic demand information may include a part name, a part quantity and a due date. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for integration of external calculations to core heuristic algorithms in accordance with one embodiment.

FIG. 2 illustrates a block diagram.

FIG. 3 illustrates a block diagram in accordance with one embodiment.

FIG. 4 illustrates a block diagram in accordance with one embodiment.

FIG. 5 illustrates a block diagram in accordance with one embodiment.

FIG. 6 illustrates a block diagram in accordance with one embodiment.

FIG. 7 illustrates a block diagram in accordance with one embodiment.

FIG. 8 illustrates solution quality (of a first metric) versus algorithm type in accordance with one embodiment.

FIG. 9 illustrates solution quality (of a second metric) versus algorithm type in accordance with one embodiment.

FIG. 10 illustrates normalized run-time versus algorithm type for each of FIG. 8 and

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

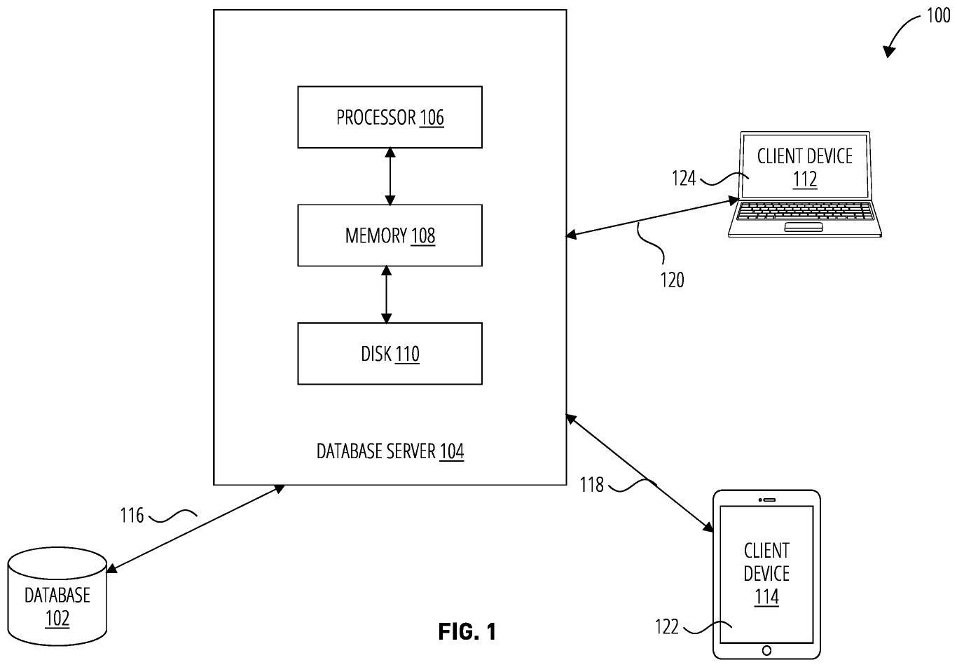

FIG. 1 illustrates an example of a system 100 for integration of external calculations to core heuristic algorithms.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104can retrieve data from database 102. The retrieved data can be saved in disk 110 or memory 108. In some cases, database server 104 can also comprise a web server, and can format resources into a format suitable to be displayed on a web browser. Database server 104can then send requested data to client devices 112 and 114 via interfaces 120 and 118, respectively, to be displayed on applications 122 and 124. Applications 122 and 124 can be a web browser or other application running on client devices 112 and 114.

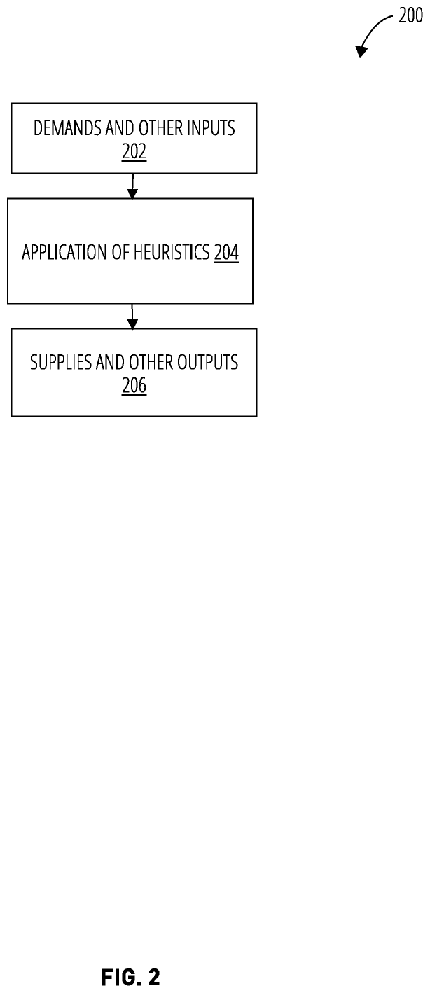

Supply planning is an example of balancing demand and supply. A heuristics-based approach attempts to create a schedule of supplies to meet one or more demands. This is illustrated by the block diagram 200 in FIG. 2, in which demand is coming in (block 202) and supply is coming out (block 206), to meet the demand. However, other inputs can be provided with the demand at block 202 that provide context to the problem at hand, including any restrictions or constraints associated with the problem. At block 204, heuristics are applied to demands and other inputs (from block 202) and outputs supply information as well as other outputs, at block 206. The additional output can provide context to the supply.

In some embodiments, other inputs include information about supply chain data, such as lead time, safety stock quantity, source of parts, etc.). In some embodiments, supply information includes planned orders, scheduled receipts, etc., while other outputs can include substitution decisions, allotment decisions, etc.

As an example, indicating that the demand is for a bicycle, is not enough. Other inputs can include whether or not the bicycle will be purchased, assembled, or partially assembled. Other input can include restrictions such as assembly at Factories A, B and C, but not Factory D. An example of output information includes priority rules such as fulfilling a demand for a large retailer as opposed to a small retailer in situations of conflicting demands. This can result in a supply with other outputs stipulating where the supply should be delivered.

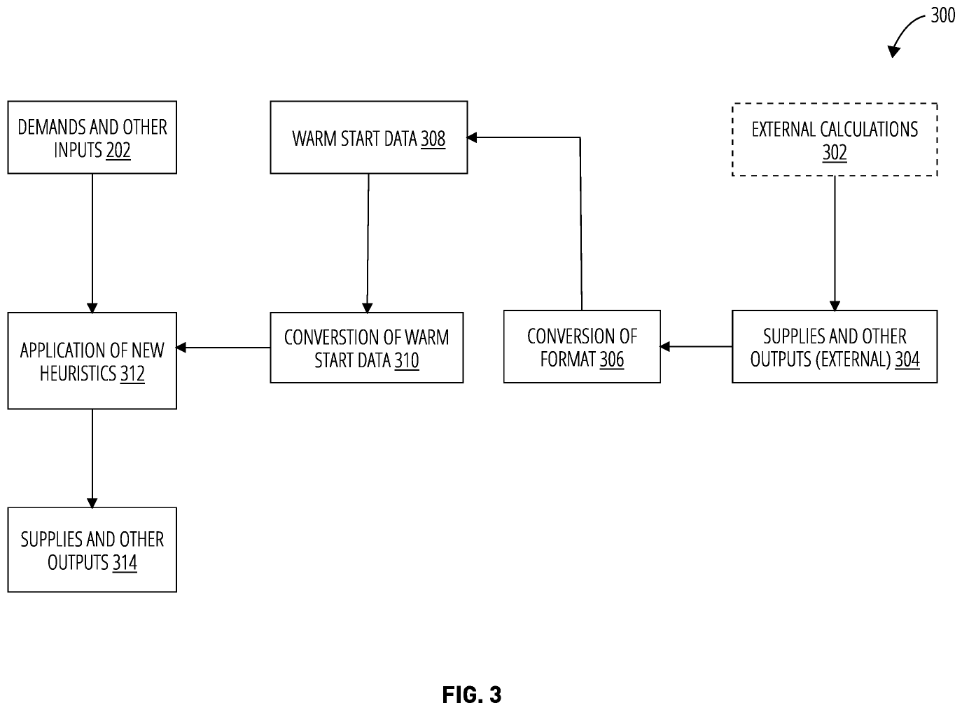

FIG. 3 illustrates a block diagram 300 in accordance with one embodiment. FIG. 3 illustrates the workflow of a scenario where external calculations 302 (for example, by an optimizer or other software system) can provide external supply and other output information (at block 304) which is transformed into warm start data 308 after conversion of format 306. Warm start data 308 is consumed by a new heuristic (block 312) along with the regular demands and inputs (block 202) to provide supplies and other outputs (block 314). Warm start data 308 can be used to enhance solutions. It should be noted that external calculations 302 are not part of the workflow of the embodiment (thus, external calculations 302 is illustrated as a dotted block); rather it is the output at block 304 that may form one of the starting points of the workflow (the other starting point being block 202).

As in FIG. 2, at block 312, heuristics are applied to the demands and other inputs from block 202. The resulting supply and other outputs are produced at block 314. Unlike FIG. 2, however, the new heuristics have two sources of input: the demands and other inputs (block 202) and warm start data 308. Note that the demands and other inputs (block 202) refer to the same data as in FIG. 2. However, the new heuristics in FIG. 3 (at block 312) are different from the heuristics in FIG. 2 (at block 204) since an additional source of data (namely, warm start data 308) will be fed to the new heuristics at block 312.

Warm start data 308 is obtained from external supplies and other outputs (block 304) that result from external calculations 302. External calculations 302 can provide another way to solve the problem initially addressed by the block diagram in FIG. 2, or aspects of the problem addressed by the block diagram in FIG. 2. That is, there may be a mapping between the results of external calculations 302 (namely external supplies and other outputs at block 304) and the external supplies and other outputs at block 206.

By solving the problem in a different way, external calculations 302 may have access to information not provided by the demand and other inputs at block 202. Continuing the example of the bicycles, it is possible that the demands and other inputs (at block 202) do not have information about holidays during the calendar year, whereas external calculations 302 does have this information when outputting external supplies and other outputs at block 304.

In addition, external calculations 302 may be any form of calculation, such as, but not limited to, optimization, machine learning, and heuristics. It should be noted that the external calculation is not the heuristic at block 204, but can be a variation of that heuristic. In addition, it is assumed that the results of external calculations 302, namely external supply and other outputs (block 304) provide better solution quality than the output at block 206. In practical terms, the run-time of the external calculations 302 can also be higher than that of the heuristics, since there is a trade-off between run-time and solution quality. That is, external calculations 302 can be better than the heuristics (of block 204) in some ways, and worse in others. Better, in that the solution quality can be higher, but worse, in that the run-time can be significantly higher.

The external supply and other outputs (block 304) contain information that is similar to the output at block 206, but are in a different format. Furthermore, this format cannot be directly fed directly to the new heuristics at block 312; it must be transformed or converted first into a format that can be fed directly to the new heuristics at block 312. The transformation or conversion take place at 306, such that the external supply and output data is converted to a format that can be fed to the new heuristic at block 312. Conversion step 306 is unique to the format of the external supply and other outputs produced at block 304. The transformed data is called warm start data 308; in an embodiment, warm start data 308 is a special type of demand.

As stated, the new heuristics at block 312 accept warm start data 308 in a particular format; that is, the new heuristics at block 312 do not accept an infinite number of formats. Thus conversion of format 306 converts external supply data and other outputs (generated at block 304) into warm start data 308 that is in a format that is accepted by the new heuristics at block 312. As an example, the external supply/output can provide weight information in terms of kilograms, whereas the new heuristics accepts information in grams; or the external supply/output provides dates, whereas the new heuristics accepts dates in terms of an offset, and so on. The format conversion thus depends on the type of information provided by the external supply/output and the corresponding format accepted by the new heuristic. Basically, the external supply/output is based on one system, whereas the new heuristics analysis is based on another system. In order for both systems to communicate to each other, the information provided by the external supply/output is converted into a format that can be accepted by the new heuristic.

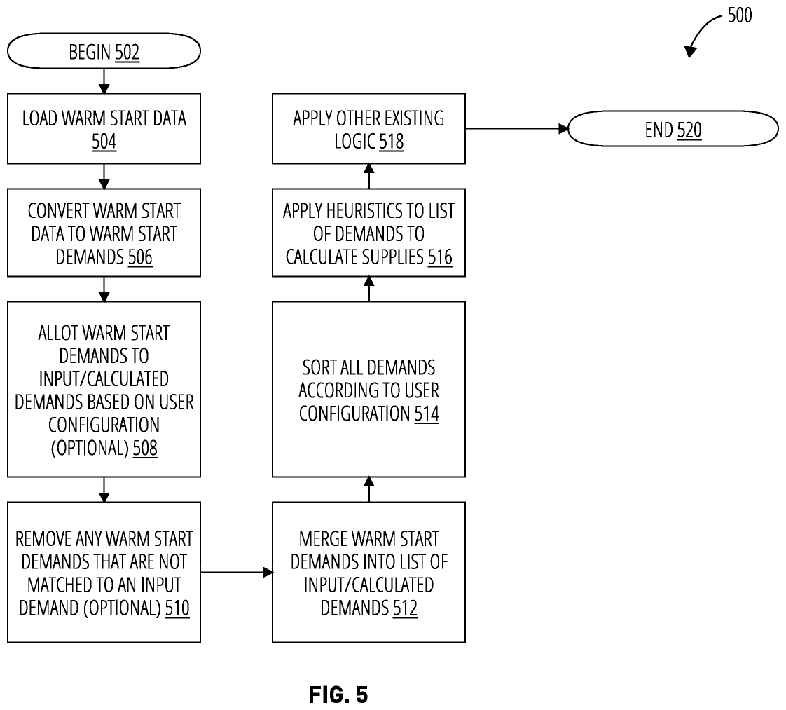

Warm start data 308 is built off of the supply and other outputs information from external calculations 302. Such additional information can be used, for example, as guidance for application of new heuristics at block 312. Instead of having just one input point (namely block 202) for the new heuristics application 312, there is now an additional input with the warm start data 308. This additional input can improve solution quality at block 314. As an example, external calculations 302 can indicate that Factory ‘B’ is better. at this time, for producing a bicycle part. This information is converted into warm start data 308, and is fed, after further conversion at block 310, to the new heuristics at block 312. Embodiments of the conversion of warm start data 308 are discussed further in reference to FIG. 5. This additional input was not initially provided by the demand and other inputs at 202. As such, with this warm start data 308, the new heuristics at block 312 can start searching for solutions only involving Factory B, rather than searching a wider scope of solutions, many of which are not feasible (that is, for those that do not include Factory B). The warm start data 308 can help to arrive at a higher quality solution in a shorter period of time.

The new heuristics at block 312 may contain a new addition to the original heuristic at block 204; the new addition accepts warm start data 308 after conversion of warm start data at block 310. That is, the new heuristics at block 312 is not the same as the heuristics at block 204, since the new heuristics at block 312 takes in additional information (in the form of warm start data 308) that the heuristics at block 204 did not have access to. The new heuristics at block 312 can have much in common with the heuristics of block 204, but it is not identical. The difference between the new heuristics at block 312 and the heuristics at block 204 can depend on the type of information in warm start data 308. Each type of information may require different handling depending on goals associated with the information and what the type of information is trying solve.

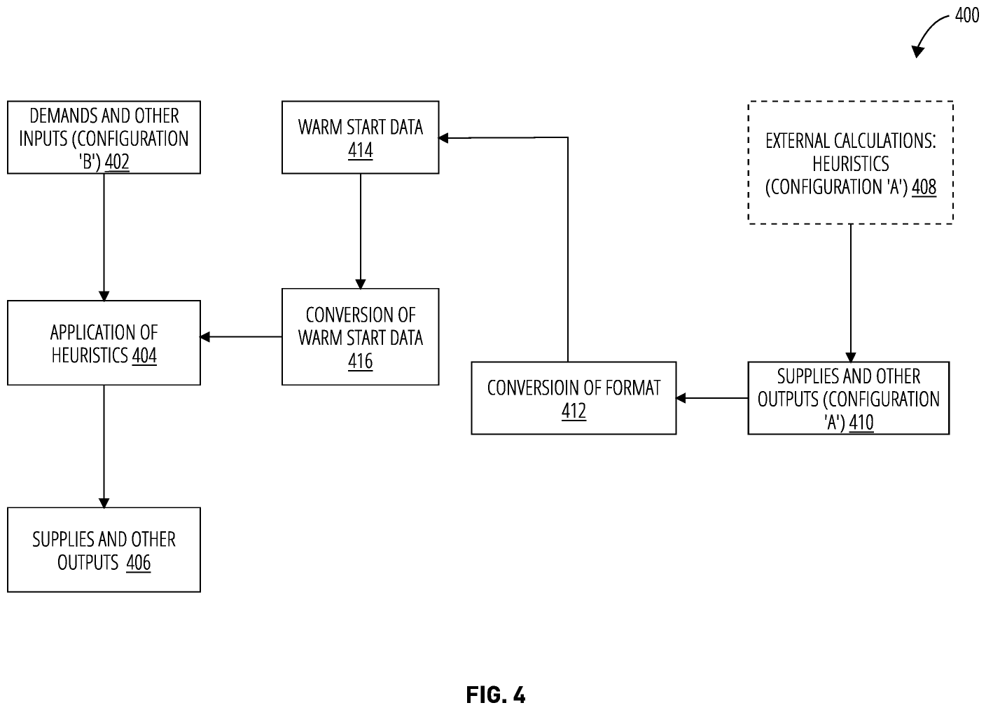

FIG. 4 illustrates a block diagram 400 in accordance with one embodiment.

In FIG. 4, the external calculation is a heuristic applied to a first configuration of demands and inputs at block 408. This configuration is labeled as Configuration ‘A’. The output, at block 410, is a set of supplies and other outputs, based on Configuration ‘A’. As discussed in detail in FIG. 3, the format of a set of supplies and other outputs, based on Configuration ‘A’, is converted at block 412 to a format that can be accepted by the heuristics of block 404. The resulting conversion is warm start data 414, which is then converted at block 416 before being fed to the heuristics at block 404.

The heuristics at block 404 also receives demands and other inputs in a configuration different from that used in block 408; this configuration is labeled as Configuration ‘B’. As such, the heuristics at block 404 receives, in the end, two different configurations of demands and other inputs: Configuration ‘B’ (at block 402) and Configuration ‘A’ (through block 410, block 412, warm start data 414 and block 416). The result of the applying the heuristics at block 404 is a set of supplies and other outputs at block 406.

In some embodiments, the heuristic used in the external calculation at block 408 is the same as that at block 404, while the respective demands and other inputs differ. In some embodiments, the heuristic used in the external calculation at block 408 are the same as that at block 404, the demands in Configuration ‘A’ (at block 408) and Configuration ‘B’ (at block 402) are the same, while the respective other inputs differ.

In some embodiments, the heuristics applied in the external calculations at block 408 are altogether different from the heuristics applied at block 404. As an example, the heuristics applied at block 408 can be a complex multi-level search that requires a longer run-time, than a simpler heuristics at block 404. Furthermore, the resulting supplies and other output (Configuration ‘A’) at block 410 requires extensive formatting changes at block 412 in order to produce warm start data 414.

As discussed with reference to FIG. 3, the external calculation can be based on any software, as long as the output (external supplies and other outputs) are somehow related to the problem addressed by the new heuristics. The external calculations can be based on, for example, optimization, machine learning, advanced heuristics, and so on. The resulting output of one or more of these external calculations can be incorporated into the simpler heuristics analysis, by converting the received output into warm start data.

FIG. 5 illustrates a block diagram 500 for incorporating warm start data into a heuristic, in accordance with one embodiment.

After external supplies and other outputs are converted into a format (at block 306) that can be accepted by the new heuristics, the converted external supplies/other output data is part of the warm start data 308. FIG. 5 illustrates a process of going from the warm start data 308 to the new heuristics at block 312, through conversion step at block 310.

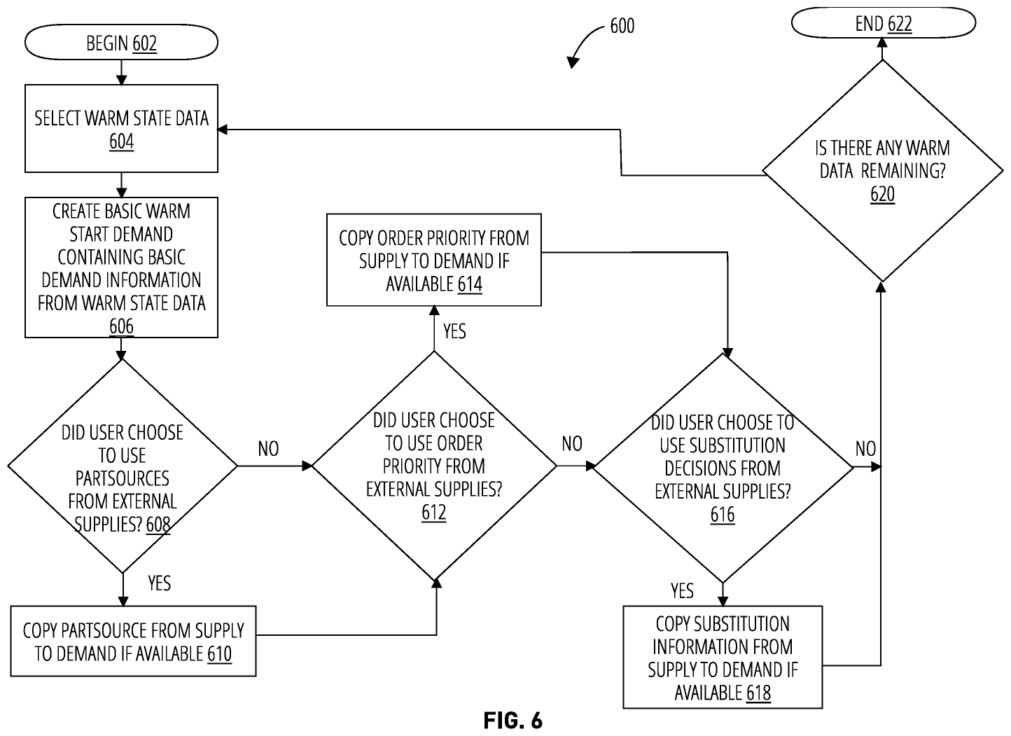

Warm start data is loaded at block 504, and is then converted to warm start demands at block 506. The warm start data (308 in FIG. 3) originates from the external supply/output data (block 304), and is thus not necessarily demand data. Therefore, the warm start data is converted into a construct that represents demand in the system so that it can be used by the new heuristic (block 312). At a basic minimum, the warm start demand is specified by a part name, part quantity and due date. That is, a demand is identified by the following: what is the part, how much is needed, and when is it needed? The external supply information is converted to a warm start demand, using this basic information, and possibly other attributes. Further details of this conversion at block 506 are discussed in FIG. 6.

Thereafter, two optional steps can follow. At block 508, the warm start demands can be optionally allotted to input/calculated demands based on user configuration. Such an optional step can enhance the overall solution quality. At block 510, warm start demands that are not matched to an input demand, can be optionally removed. Such an optional step can reduce the run-time. At block 512, warm start demands are merged into list of input/calculated demands. All demands can then be sorted according to user configuration at block 514. Subsequently, heuristics are applied to list of demands to calculate supplies at block 516. Finally, other existing logic can be applied at block 518, before the procedure ends at 520. Block 518 refers to an optional post-processing step.

The optional allotment step at block 508 may be performed by various techniques, such as by due date, by priority, and so forth. The specific algorithm used can be changed depending on the goal of the heuristic and can be configured by the user. Likewise, the sorting of all demands at block 514 can also be performed in different ways, depending on a configuration specified by the user. It should be noted that the processing order can have an effect of the solution provided by application of the new heuristics.

Some common examples include sorting by due date, by priority, by Warm Start vs Input demand, and so on. In a simple example, a user may configure the order to process in the order of due dates of the demands. Or the user may configure the order to process in the order of demand priority. Or a mixture of both, or further criteria. In some embodiments, the warm start demands are listed ahead of the input/calculated demands. Where a user stipulates further sorting criteria, the sorting can take place within each category of demands (that is warm-start demands, input demands, calculated demands). For example, if a user stipulates demand priority as a configuration, the first set of demands are warm start demands that are sorted according to priority within this set; the next set of demands are input demands that are sorted according to priority within this set; and the final set of demands are calculated demands that are sorted according to priority within this set.

FIG. 6 illustrates a block diagram 600 for converting warm start data to warn start demands (block 506 in FIG. 5) in accordance with one embodiment.

First, at block 604, a piece of warm start data is selected (the piece of warm start data corresponds to a converted form of external supply/output information). A basic warm start demand is then created at block 606 from the external supply. This can include basic demand information such as the part, due date and quantity, based on the external supply data. As an example, a piece of warm start data can indicate that a certain part is produced in an amount of 200 units on Monday. That information can be converted into a warm start demand that is defined by the part, being produced in 200 units on Monday. Additional information provided by the warm start data can also be incorporated into the construct of the warm start demand. For example, the external supply may provide information about where a certain part is obtained from (that is, source location), as well as whether the part was bought or assembled. Such additional information is converted into a demand construct, which comprises basic demand information (part, quantity, due date) and additional information.

As discussed below, basic demand information (that is part, quantity, due date) is handled slightly differently than the additional information. The additional information is copied and saved into the demand construct for later application by the new heuristics. It is possible the new heuristics may be applied to the additional information first.

The series of decision blocks (608, 612 and 616) refer to incorporating additional information from the external supply that may not be available from the traditional demands and other inputs of block 202. Each decision block refers to a specific type of information that is checked; while three decision blocks are shown, it is understood that there can be fewer or more. In the embodiment shown in FIG. 6, the following additional three types of information are checked for: PartSource (that is, where the part originates from); Order Priority (relative priorities between different demands; in some user configurations, higher priority demands are processed first); and Substitution Decisions (can the part be substituted by another part?).

Decision block 608 then checks to see if the user chose to use the entity “PartSources” from the external supplies. If yes, then the “PartSource” information is copied from the external supply to the demand, if available, at block 610. “If available” refers to the following situation: external calculations may or may not provide the information, either because they do not calculate it at all, or, because the data provided does not include it. The system uses the information only if it is available and if the user chooses to use it. This applies also to any of the optional data described in FIG. 6, such as block 614 and block 618.

If no, then decision block 612 checks to see if the user chose to use the entity “Order Priority” from the external calculations. If yes, then “Order Priority” is copied from the external supply to the demand, if available. If no, then decision block 616 checks to see if the user chose to use substitution decisions from the external supplies. If yes, then the substitution information is copied from the external supply to the demand, if available. If no, then decision block 620 checks to see if there are further warm start data remaining. If yes, then the next piece of warm start data is selected at block 604; otherwise, the procedure ends at 622.

FIG. 6 illustrates examples of the external supply attributes that can be used (selectable by the user). The methods and systems are not limited to the attributes shown in FIG. 6 (i.e. Part, due date, quantity, “PartSource”, “Order Priority”), but may include other attributes as required. Attributes that are not copied or are unavailable but are required to generate supplies, can be re-calculated by the heuristic.

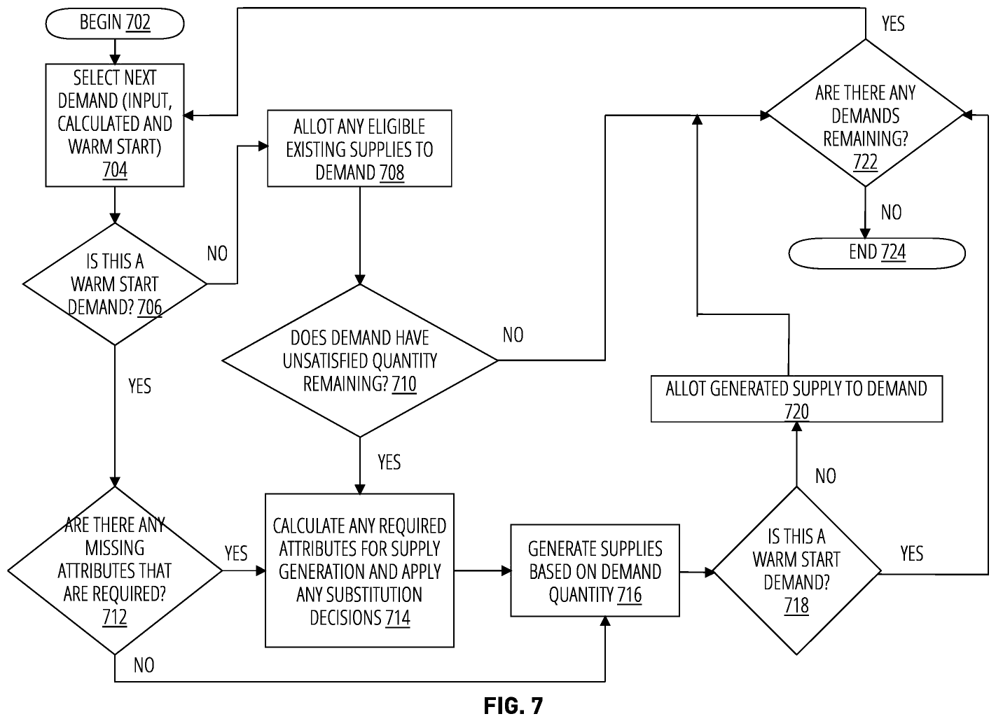

FIG. 7 illustrates a block diagram for applying heuristics to a list of demands to calculate supplies (block 516 in FIG. 5) in accordance with one embodiment.

First, at block 704, a demand is selected from the list compiled at block 512 in FIG. 5. The list consists of input demands from block 202, calculated demands and warm start demands from warm start data. Decision block 706 then checks to see if the demand is a warm start demand.

If the demand is a warm start demand (‘yes’ at decision block 706), then decision block 712 checks to see if there are any missing attributes that are required. If there are any missing attributes that are required (‘yes’ at decision block 712), then at block 714, any required attributes for supply generation are calculated and any substitution decisions can be applied. In some embodiment, the substitution is a Bill of Materials substitution.

Next, supplies based on demand quantity are generated at block 716. If there are no missing attributes that are required at decision block 712, then supplies based on demand quantity are directly generated at block 716. At this point decision block 718 checks to see if the demand is a warm start demand. If not, then the generated supply is allotted to demand at block 720, before checking to see if there are any demands remaining at decision block 722. If yes, then decision block 722 checks to see if there are any demands remaining. The procedure ends at 724 if no further demands remain; otherwise it returns to block 704 to begin processing the next demand.

If the demand is not a warm start demand ('no' at decision block 706), then any eligible existing supplies are allotted to demand at block 708. Decision block 710 then checks to see if the demand has any unsatisfied quantity remaining. If not, then decision block 722 checks to see if there are any demands remaining—at which point, the procedure ends at 724 if no further demands remain; otherwise it returns to block 704 to begin processing the next demand.

If, on the other hand, the answer is ‘yes’ at decision block 710, then at block 714, any required attributes for supply generation are calculated and BOM substitution decisions are applied. Next, supplies based on demand quantity are generated at block 716. At this point decision block 718 checks to see if the demand is a warm start demand. If not, then the generated supply is allotted to demand at block 720, before checking to see if there are any demands remaining at decision block 722. If yes, then decision block 722 checks to see if there are any demands remaining. The procedure ends at 724 if no further demands remain; otherwise it returns to block 704 to begin processing the next demand.

In FIG. 7, warm start demands can generate supplies, but will not be allotted any supply. The warm start demands are considered satisfied after generating supplies matching the quantity of the demand. Input and calculated demands can be allotted existing supplies, including supplies generated by warm start demands earlier in the process. The eligibility of supplies depends on the input configuration.

It follows that warm start demands that are processed before an input or a calculated demand can be influenced by the warm start data from the external calculation. The extent of the influence may depend on the number of attributes copied from the warm start data.

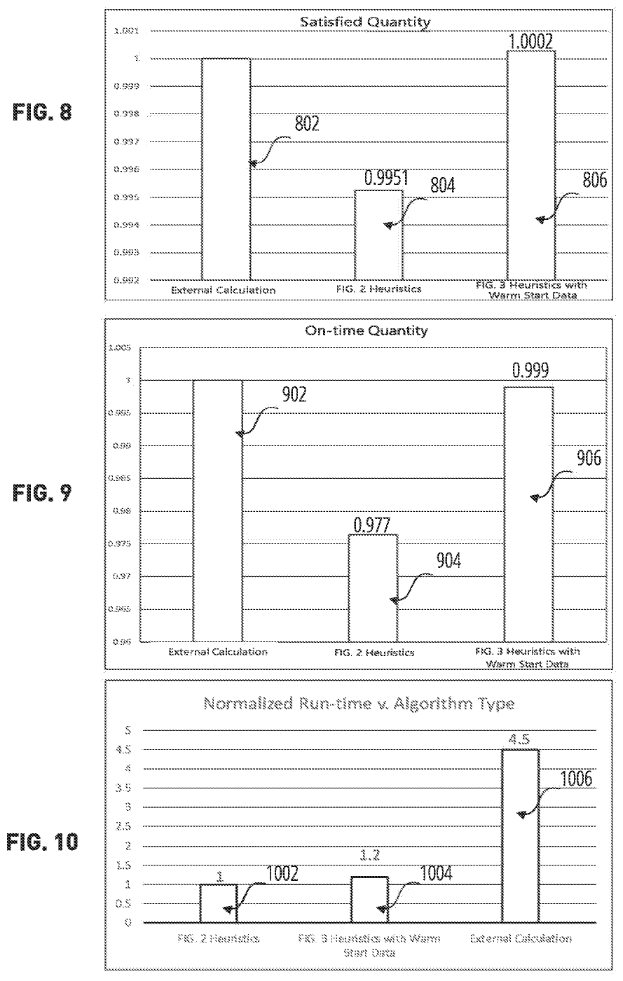

FIG. 8 illustrates solution quality (of a first metric) versus algorithm type in accordance with one embodiment.

In FIG. 8, the quality of solution for satisfied quantity is shown for three different algorithm types, with the external calculation normalized as 1. Satisfied quantity refers to a maximum quantity available at all times. As an example, there may be a demand for 200 bicycles at a certain location, yet there may only be 90 bicycles available in the whole world at any given time. The satisfied quantity is thus 90.

In FIG. 8, the external calculation 802 provides a solution quality that is normalized to 1; namely, it is expected to provide the highest quality solution for satisfied quantity. If the heuristics of FIG. 2 are used to solve the same problem, the solution quality 804 is less, with a value of 0.9951. Finally, if the heuristics of FIG. 3 are used along with the warm start data that originates from the external calculations, the solution quality 806 is slightly better than the external calculations with a value of 1.0002. That is, once information from the external calculations is included in the heuristics of FIG. 3, the solution output is comparable to that of the external calculation. It is a marked improvement from the solution quality of the FIG. 2 heuristics alone (see 806 v. 804).

FIG. 9 illustrates solution quality (of a second metric) versus algorithm type in accordance with one embodiment.

In FIG. 9, the quality of solution for on-time quantity is shown for three different algorithm types, with the external calculation normalized as 1. In FIG. 9, the external calculation 902 provides a solution quality that is normalized to 1; namely, it is expected to provide the highest quality solution for on-time quantity. If the heuristics of FIG. 2 are used to solve the same problem, the solution quality 904 is less, and normalized to a value of 0.977. Finally, if the heuristics of FIG. 3 are used along with the warm start data that originates from the external calculations, the solution quality 806 is comparable to the external calculations with a value of 0.999. That is, once information from the external calculations is included in the heuristics of FIG. 3, the solution output is comparable to that of the external calculation. It is a marked improvement from the solution quality of the FIG. 2 heuristics alone (see 906 v. 904).

The examples in FIG. 8 and FIG. 9 demonstrate a scenario where the external calculation performs better than the standard heuristics of FIG. 2, with the results are shown relative to the results of the external calculation. When warm start data from the external calculation is used with the heuristics of FIG. 3, the results in both the Satisfied Quantity (FIG. 8) and On-time Quantity (FIG. 9) metrics improve and are much closer to the results seen with the external calculation, demonstrating the improved influence of the warm start data.

FIG. 10 illustrates normalized run-time versus algorithm type for each of FIG. 8 and FIG. 9.

In FIG. 10, the run-time to execute each of the algorithms used in either of FIG. 8 or FIG. 9 is presented, with the run-time 1002 of the FIG. 2 heuristics normalized to 1. What is of significance is that the run-time 1004 of the FIG. 3 heuristics with warm start data is roughly 20% greater than that of the FIG. 2 heuristics (1002), while providing a significant improvement in solution quality for both satisfied quantity (806 versus 804) and on-time quantity (906 versus 904). In addition, the heuristics of FIG. 3 with warm start data provides comparable solution quality with that obtained by external calculations quality of solution for both satisfied quantity (806 versus 802) and on-time quantity (906 versus 902). Yet the external calculations take almost four times longer (or 400%) in run-time than the run-time of FIG. 3 heuristics with warm start data (1006 versus 1004). This demonstrates that integration of warm start data (originating from external calculations) into a heuristics greatly enhances solution quality relative to a standard heuristic, while greatly reducing run-time relative to an external calculation.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a processor, a set of external supplies and one or more external outputs based on an external calculation;
converting, by the processor, a format of the set of external supplies and the one or more external outputs into a converted format that is receivable by a heuristic application;
generating, by the processor, warm start data from the converted format;
converting, by the processor, the warm start data to a set of converted warm start data;
inputting, by the processor, a set of demands and one or more inputs, to the heuristic;
inputting, by the processor, the set of converted warm start data to the heuristic;
applying, by the processor, the heuristic to the set of demands, the one or more inputs, and the set of warm start data; and
generating, by the processor, a set of supplies and one or more outputs based on the heuristics applied to the set of demands, the one or more inputs, and the set of converted warm start data.

2. The computer-implemented method of claim 1, wherein prior to inputting the set of converted warm start data to the heuristic, the method further comprises:
loading, by the processor, the warm start data;
converting, by the processor, the warm start data to a set of warm start demands;
merging, by the processor, the set of warm start demands into a list comprising the set of demands and a set of calculated demands; and
sorting, by the processor, the list according to a user-defined configuration.

3. The computer-implemented method of claim 2, wherein converting the warm start data to the set of warm start demands comprises:
selecting, by the processor, a piece of warm start data;
creating, by the processor, a warm start demand from the piece of warm start data, the warm start demand having a demand construct comprising basic demand information, the demand construct receivable by the heuristic; and
incorporating, by the processor, additional warm start demand information into the demand construct of the warm start demand.

4. The computer-implemented method of claim 3, wherein the basic demand information comprises a part name, a part quantity and a due date.

5. The computer-implemented method of claim 1, wherein the external calculation is based on machine learning, optimization or a second heuristic.

6. The computer-implemented method of claim 1, wherein the external calculation is the heuristic, the heuristic having an input configuration that is different from the set of demands and the one or more inputs.

7. A system comprising:
a processor; and
a memory storing instructions that, when executed by the processor, configure the system to:
receive, by the processor, a set of external supplies and one or more external outputs based on an external calculation;
convert, by the processor, a format of the set of external supplies and the one or more external outputs into a converted format that is receivable by a heuristic application;
generate, by the processor, warm start data from the converted format;
convert, by the processor, the warm start data to a set of converted warm start data;
input, by the processor, a set of demands and one or more inputs, to the heuristic;
input, by the processor, the set of converted warm start data to the heuristic;
apply, by the processor, the heuristic to the set of demands, the one or more inputs, and the set of warm start data; and
generate, by the processor, a set of supplies and one or more outputs based on the heuristics applied to the set of demands, the one or more inputs, and the set of converted warm start data.

8. The system of claim 7, wherein prior to inputting the set of converted warm start data to the heuristic, the system is further configured to:
load, by the processor, the warm start data;
convert, by the processor, the warm start data to a set of warm start demands;
merge, by the processor, the set of warm start demands into a list comprising the set of demands and a set of calculated demands; and
sort, by the processor, the list according to a user-defined configuration.

9. The system of claim 8, wherein when converting the warm start data to the set of warm start demands, the system is further configured to:
select, by the processor, a piece of warm start data;
create, by the processor, a warm start demand from the piece of warm start data, the warm start demand having a demand construct comprising basic demand information, the demand construct receivable by the heuristic; and
incorporate, by the processor, additional warm start demand information into the demand construct of the warm start demand.

10. The system of claim 9, wherein the basic demand information comprises a part name, a part quantity and a due date.

11. The system of claim 7, wherein the external calculation is based on machine learn, optimization or a second heuristic.

12. The system of claim 7, wherein the external calculation is the heuristic, the heuristic having an input configuration that is different from the set of demands and the one or more inputs.

13. A non-transitory computer-readable storage medium, the computer-readable storage medium including instructions that when executed by a computer, cause the computer to:
receive, by a processor, a set of external supplies and one or more external outputs based on an external calculation;
conversion, by the processor, of a format of the set of external supplies and the one or more external outputs into a converted format that is receivable by a heuristic application;
generate, by the processor, warm start data from the converted format;
convert, by the processor, the warm start data to a set of converted warm start data;
inputting, by the processor, a set of demands and one or more inputs, to the heuristic;
inputting, by the processor, the set of converted warm start data to the heuristic;
apply, by the processor, the heuristic to the set of demands, the one or more inputs, and the set of warm start data; and
generate, by the processor, a set of supplies and one or more outputs based on the heuristics applied to the set of demands, the one or more inputs, and the set of converted warm start data.

14. The computer-readable storage medium of claim 13, wherein prior to inputting the set of converted warm start data to the heuristic, the instructions that when executed by the computer, further cause the computer to:
load, by the processor, the warm start data;
convert, by the processor, the warm start data to a set of warm start demands;
merge, by the processor, the set of warm start demands into a list comprising the set of demands and a set of calculated demands; and
sort, by the processor, the list according to a user-defined configuration.

15. The computer-readable storage medium of claim 14, wherein converting the warm start data to the set of warm start demands, the instructions that when executed by the computer, further cause the computer to:
select, by the processor, a piece of warm start data;
create, by the processor, a warm start demand from the piece of warm start data, the warm start demand having a demand construct comprising basic demand information, the demand construct receivable by the heuristic; and
incorporate, by the processor, additional warm start demand information into the demand construct of the warm start demand.

16. The computer-readable storage medium of claim 15, wherein the basic demand information comprises a part name, a part quantity and a due date.

17. The computer-readable storage medium of claim 13, wherein the external calculation is based on machine learn, optimization or a second heuristic.

18. The computer-readable storage medium of claim 13, wherein the external calculation is the heuristic, the heuristic having an input configuration that is different from the set of demands and the one or more inputs.
